(19) United States
(12) Patent Application Publication
(10) Pub. No.: US 2026/0369936 A1
(43) Pub. Date: Nov. 19, 2026

(54) Grounding Shield for High Speed Connector

(71) Applicant: TE Connectivity Solutions GmbH, Schaffhausen (CH)

(72) Inventors: Keith Edwin MILLER, Manheim, PA (US); Charles Raymond GINGRICH, III, Mechanicsburg, PA (US); Scott Eric WALTON, Mount Joy, PA (US)

(73) Assignee: TE Connectivity Solutions GmbH, Schaffhausen (CH)

(21) Appl. No.: 19/207,430

(22) Filed: May 14, 2025

(51) Int. Cl. H01R 13/6587; H01R 12/73; H01R 13/05; H01R 13/514; H01R 13/652; H01R 13/6582

(52) U.S. Cl. CPC H01R 13/6587; H01R 12/737; H01R 13/05; H01R 13/514; H01R 13/652; H01R 13/6582

(57) ABSTRACT

A backplane connector having a housing with a mating end and a mounting end for mounting to a substrate. One or more substrate receiving slots extend from the mating end toward the mounting end. Ground shield support surfaces are provided proximate the one or more substrate receiving slots. Signal contacts extend between the mating end and the mounting end. The signal contacts have resilient contact arms which extend into the substrate receiving slot. At least one ground shield contact member extends between the mating end and the mounting end. The at least one ground shield contact member have working spring portions with openings provided therein. Housing cooperating surfaces are positioned at the periphery of the openings. The housing cooperating surfaces engage the ground shield support surfaces to allow forces applied to the housing to be transferred to the at least one ground shield contact member.

### FIELD OF THE INVENTION

The invention relates generally to a grounding shield for a high speed connector. In particular, the invention is directed to a grounding shield with small openings which provide stability to the shield while optimizing signal integrity.

### BACKGROUND OF THE INVENTION

Backplane systems, such as network systems, servers, data centers, and the like, include a backplane circuit board having electrical connectors mounted thereto. The electrical connectors may include dense arrays of signal contacts, ground contacts and grounding shields. The signal contacts, ground contacts and grounding shields have respective contact tails arranged along a mounting side of the electrical connector. The contact tails have a press-fit configuration which are configured to be inserted into vias, such as plated thru-holes (PTHs), of the circuit board. Because there are multiple contact tails extending from the grounding shields, the force required to insert the press-fit contact tails into the plated thru-holes can be significant. As many of the grounding shields are not properly supported by the housing of the connector, the press-fit contact tails may not be properly seated in the thru-holes. In instances in which the grounding shields have additional support to provide for the proper forces, the configuration of the grounding shields has poor signal integrity performance due to the configuration of the grounding shields.

It would therefore be beneficial to provide an electrical connector in which the grounding shields with press-fit contact tails are provided with provided with adequate support to withstand and stabilize the forces applied to the grounding shields during assembly of the connector onto the backplane circuit board. In addition, it would optimize the signal integrity performance of the stabilized grounding shields.

### SUMMARY OF THE INVENTION

The following provides a summary of certain illustrative embodiments of the present invention. This summary is not an extensive overview and is not intended to identify key or critical aspects or elements of the present invention or to delineate its scope.

An embodiment is directed to a backplane connector having a housing with a mating end and a mounting end for mounting to a substrate. One or more substrate receiving slots extend from the mating end toward the mounting end. Ground shield support surfaces are provided proximate the one or more substrate receiving slots. Signal contacts extend between the mating end and the mounting end. The signal contacts have resilient contact arms which extend into the one or more substrate receiving slots. At least one ground shield contact member extends between the mating end and the mounting end. The at least one ground shield contact member have working spring portions with openings provided therein. Housing cooperating surfaces are positioned at the periphery of the openings. The housing cooperating surfaces engage the ground shield support surfaces to allow forces applied to the housing to be transferred to the at least one ground shield contact member.

An embodiment is directed to a backplane connector having a housing with a mating end and a mounting end for mounting to a substrate. One or more substrate receiving slots extend from the mating end toward the mounting end. Ground shield support surfaces are provided proximate the one or more substrate receiving slots. The ground shield support surfaces extend in a plane which is essentially parallel to a plane of the mounting end. Signal contacts extend between the mating end and the mounting end, the signal contacts have resilient contact arms which extend into the one or more substrate receiving slots. At least one ground shield contact member extends between the mating end and the mounting end. The at least one ground shield contact member has curved working spring portions with openings provided therein with housing cooperating surfaces positioned at the periphery of the openings. The at least one ground shield contact member has mounting compliant members which extend from an end of the at least one ground shield contact member through the mounting end of the housing. Solid portions extend between the openings. The solid portions are configured to optimize ground currents within the at least one ground shield contact member. The housing cooperating surfaces engage the ground shield support surfaces to allow forces applied to the housing to be transferred to the at least one ground shield contact member.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature

### BRIEF DESCRIPTION OF THE DRAWINGS

FIG. 1 is a bottom perspective of an illustrative electrical connector of the present invention with an illustrative grounding shield exploded therefrom.

FIG. 2 is an enlarged bottom perspective of a portion of the electrical connector with grounding shields fully inserted into slots of the housing.

FIG. 3 is a bottom view of a portion of the electrical connector with grounding shields fully inserted into slots of the housing.

FIG. 4 is a cross-sectional view of the electrical connector taken along line 4-4 of FIG. 3.

FIG. 5 is perspective view of an illustrative grounding shield according to the present invention.

FIG. 6 is a cross-sectional view of the electrical connector which best shows the signal contacts.

FIG. 7 is a cross-sectional view of the electrical connector which best shows the ground contacts.

FIG. 8 is a cross-sectional view similar to FIG. 6, with circuit boards positioned in circuit board receiving slots of the electrical connector.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

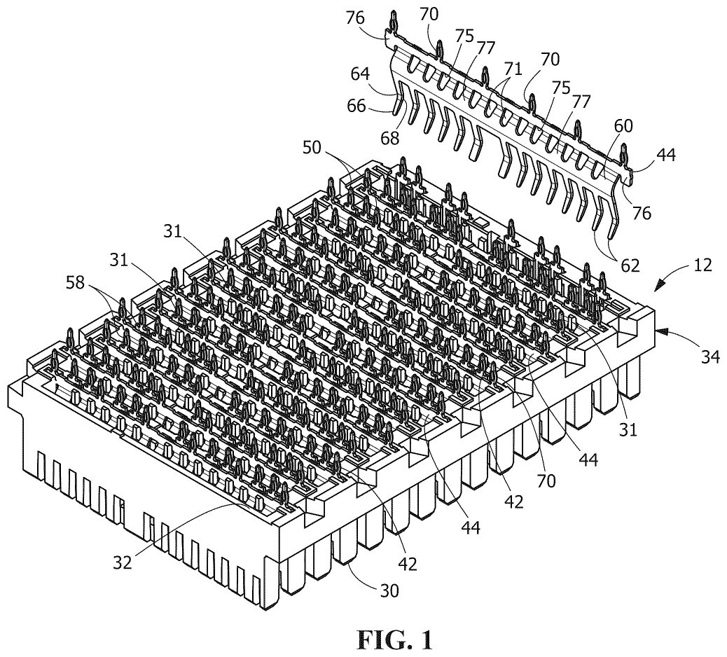

FIG. 1 illustrate an illustrative backplane connector 12. Such backplane connectors can be used, for example, to mate with substrates or wafers 22 (FIG. 8) of a daughtercard connector (not shown) that are used to electrically connect a backplane circuit board 16 (FIGS. 6 through 8) and a daughtercard circuit board (not shown). In the illustrated embodiment, the backplane connector 12 constitutes a header connector which mounted to the backplane circuit board 16. However, other types of connectors may be used.

The backplane connector 12 includes a mating end 30 and a mounting end 32 that are oriented generally parallel to one another. The backplane connector 12 is mounted to the backplane circuit board 16 at the mounting end 32, as shown in FIGS. 6 through 8.

In the illustrative embodiment, the backplane connector 12 includes a one piece housing 34. Alternatively, the housing may include a plurality of individual housings or modules. The housing 34 has one or more substrate or wafer receiving slots 36 which extend from the mating end 30 toward the mounting end 32.

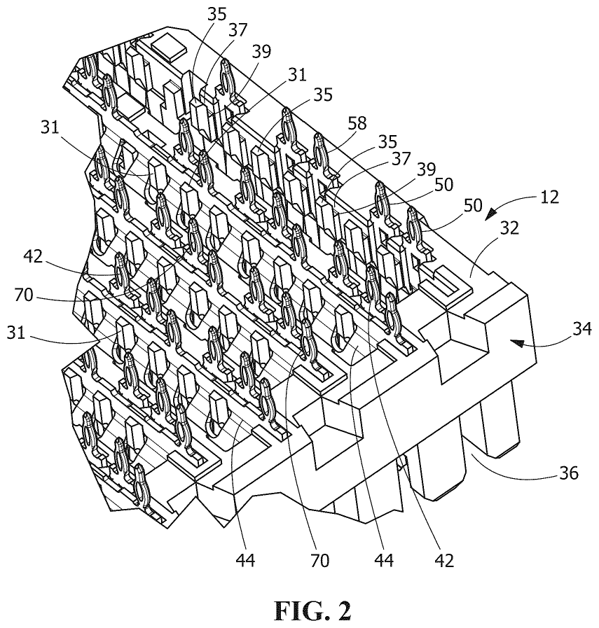

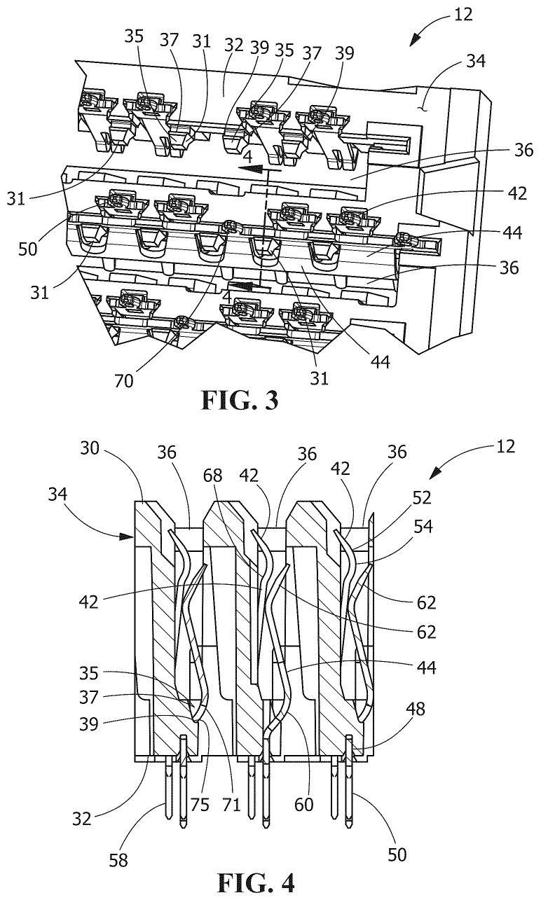

Projections 31 are provided on the housing 34 and extend from the mounting end 32 is a direction away from the mating end 30. The projections 31 are positioned proximate one or more of the wafer receiving slots 36. As shown in FIGS. 2, 3 and 6 through 8, the projections have free ends 35 which are spaced from the mounting end 32 of the housing 34. Ground shield receiving slots 37 extend from the free ends 35 toward the mating end 30. Ground shield support surfaces 39 are provided at the ends of the ground shield receiving slots 37. The ground shield support surfaces 39 extend in a plane which is essentially parallel to the plane of the mounting end 32. In the illustrative embodiment shown, the interval or spacing between the projections 31 is essentially equal, however, other configuration may be used.

The housing 34 holds at least one row of signal contacts 42 and at least one ground shield contact member 44. The at least one row of signal contacts 42 are positioned on one side of the one or more wafer receiving slots 36. The at least one ground shield contact member 44 is positioned on an opposed side of the one or more wafer receiving slots 36.

The signal contacts 42 extend between the mating end 30 and the mounting end 32. In the exemplary embodiment, the signal contacts 42 are arranged in pairs carrying differential signals. However, in other configurations, the signal contacts 42 may not be arranged in pairs for carrying differential signals, such as carrying single ended signals. The ground shield contact member 44 extends between the mating end 30 and the mounting end 32.

As shown in FIGS. 6 through 8, each signal contact 42 has a resilient contact arm 46, a securing section 48 and circuit board mounting section 50. In the illustrative embodiment shown, each of the resilient contact arms 46 has a lead in portion 52 and an engagement portion 54. The resilient contact arms 46 are configured to press against signal conductive pads of the signal traces of wafers 22 of the daughter card connector when the wafers 22 are inserted into the wafer receiving slots 36 of the backplane connector 12.

The securing sections 48 have retention members 56, which may be, but are not limited to barbs or projections, which extend from surfaces of the securing sections 48. The retention members 56 cooperate with the housing 34 to retain the signal contacts 42 in the backplane connector 12.

The circuit board mounting sections 50 have compliant portions 58, such as an eye of the needle pins, although other configurations may be used. The configuration of the signal contacts 42 is meant to be illustrative as other embodiments of the signal contacts may be used. For example, the signal contacts 42 may have asymmetrical or other configurations which allows for optimal performance under different conditions. The circuit board mounting sections 50 cooperate with the backplane circuit board to retain the signal contacts 42 to the backplane circuit board.

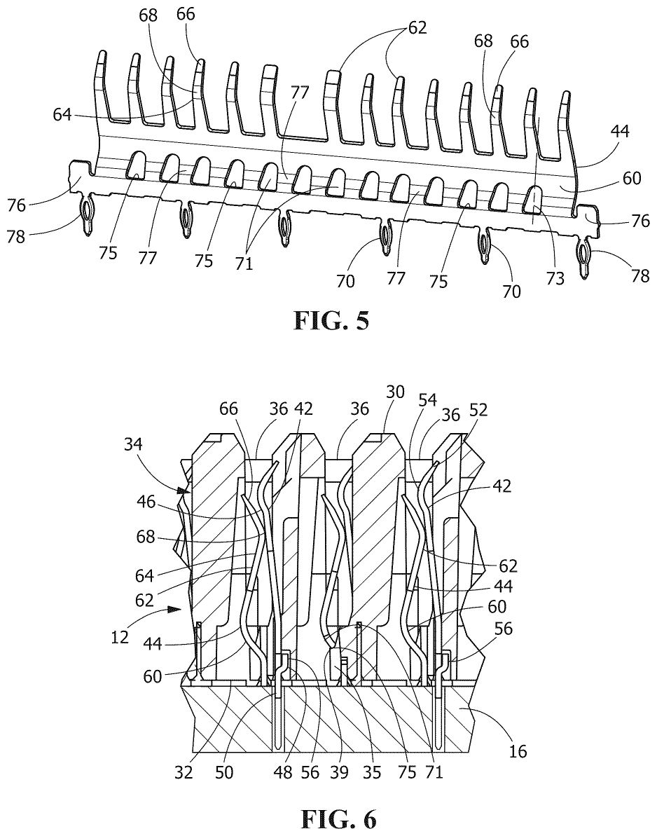

As shown in FIGS. 1 and 5, the ground shield contact members 44 have curved working spring portions 60. Ground shield resilient contact beams or ground shield contact spring fingers 62 extend from first ends of the curved working spring portions 60. In the illustrative embodiment shown, the spacing between the ground shield contact beams 62 varies along the length of the curved working spring portions 60, however other configurations may be used, such as the ground shield contact beams 62 may be spaced uniformly along the length of the curved working spring portions 60. The ground shield contact members 44 make the ground connection between the backplane circuit board 16 and the wafers 22 and are configured to provide both mechanical integrity and signal integrity.

The ground shield contact beams 62 have ground shield resilient contact arms 64 with lead in portions 66 and an engagement portions 68. The resilient contact arms 64 are configured to press against the ground plane member of the substrates or wafers 22 when the daughter card connector is mated to the backplane connector 12. The particular configuration of each of the ground shield contact beams 62 may vary or may be uniform.

Mounting members 70 extend from second ends of the curved working spring portions 60. The second ends of the curved working spring portions 60 are opposed to the first ends of the curved working spring portions 60. In the illustrative embodiment shown, the resilient members 70 are spaced uniformly along the length of the working spring portions 60, however other configurations may be used. In the embodiment shown, the mounting members 70 are eye of the needle compliant members, but other types of mounting members 70 may be used. The mounting members 70 are configured to engage and make an electrical connection with through holes 18 of the backplane circuit board 16.

Openings 71 are provided in the curved working spring portions 60. In the illustrative embodiment shown, the openings 71 are spaced uniformly along the length of the working spring portions 60, however other configurations may be used. Also in the illustrative embodiment shown, the longitudinal axes 73 of the openings 71 are in line with longitudinal axes of the ground shield resilient contact arms 64. The openings are dimensioned to be large enough to receive the projections 31 of the housing 34 therein, while being small enough to optimize signal integrity performance.

Housing cooperating surfaces 75 are provided about portions of the peripheries of the openings 71. The housing cooperating surfaces 75 extend in a plane which is generally perpendicular to the longitudinal axes 73 of the openings 71 and generally parallel to planes of the ends of the curved working spring portions 60.

Solid portions 77 are positioned on the curved working spring portions 60 between the openings 71 and ground shield contact beams 62. The solid portions 77 are provided to optimize ground currents within the ground shield contact members 44 and within the backplane connector 12.

In the illustrative embodiment shown, ground contacts 76 are provided at the ends of the working spring portion 60. The ground contacts 76 provide additional ground connections between ground shields of the daughtercard connector and the backplane 16. In addition, the ground contacts 76 provided at the ends of the ground shield contact members 44 also provide stability and support. In the illustrative embodiment shown, the ground contacts 76 extend approximately essentially in line with the working spring portion 60 and have securing portions 78. In the embodiment shown, the securing portions 78 are eye of the needle compliant members, but other types of securing portions 78 may be used.

In use, the housing 34 is brought into engagement and mounted to the backplane circuit board 16. As this occurs, the circuit board mounting sections 50 of the signal contacts 42 and the mounting members 70 of the ground shield contact members 44 are positioned in line and inserted into thru holes of the backplane circuit board 16. As insertion occurs, force must be supplied to the signal contacts 42 to force the circuit board mounting sections 50 into the thru holes. As the signal contacts 42 are retained in the housing 34 by securing sections 48, the force needed for to insert the signal contacts 42 can be applied to the housing 34 and transferred to the circuit board mounting sections 50 through the engagement of the retention members 56 of the securing sections 48 with the housing 34.

As insertion occurs, force must be supplied to the ground shield contact members 44 to force the mounting members 70 into the thru holes. As a force is applied to the housing 34, the ground shield support surfaces 39 of the projections 31 engage the housing cooperating surfaces 75 of the ground shield contact members 44 which are positioned in the ground shield receiving slots 37 of the projections 31. As force in continued to be applied to the housing 34, the ground shield support surfaces 39 of the projections 31 transfer the force to the housing cooperating surfaces 75 of the ground shield contact members 44, forcing the mounting members 70 into the thru holes of the backplane circuit board 16.

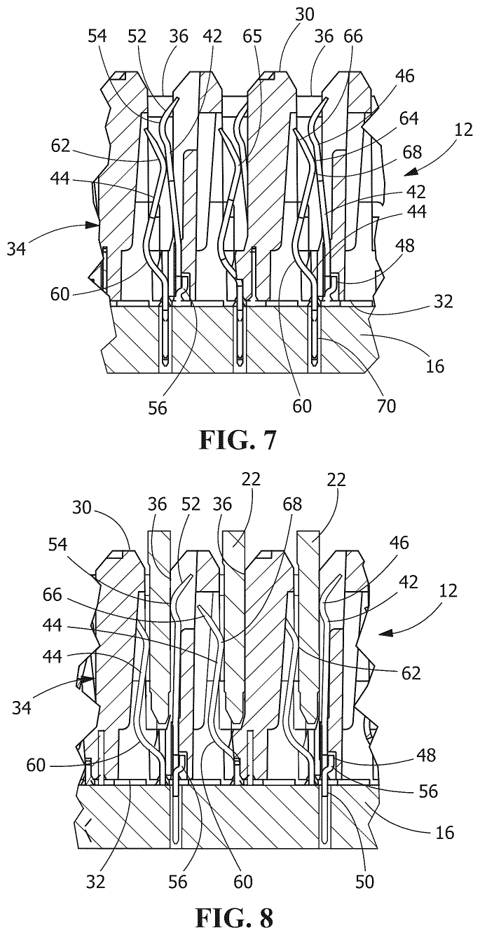

With the backplane connector 12 properly mounted to the backplane circuit board 16, the insertion of the wafers 22 into the wafer receiving slots 36 can occur, as illustrated in FIGS. 7 and 8. Due to the configuration of the ground shield contact members 44, including the curved working spring portions 60, the force applied by the resilient contact arms 64 to the wafers 22 results in the resilient contact arms 64 of the ground shield contact members 44 biasing the wafers 22 toward the resilient contact arms 46 of the signal contacts 42.

The configuration of the openings 71 and the housing cooperating surfaces 75 of the ground shield contact members 44 creates multiple openings and housing cooperating support surfaces that cooperate with the housing. The placement and design of the small windows optimizes signal integrity performance while creating adequate surface area to stabilize the shield and support it against the forces applied to the shield during assembly of the connector onto the backplane PCB. The configuration of the ground shield contact members 44 also minimizes the overall size of the shield while maximizing the length of the spring working area of the shield. The shield design has individual beam fingers that ensure multiple points of contact to the mating wafer. It also has a solid area between the small windows and the beam fingers to optimize ground currents within the connector. Extensions on the end of the shield also provide stability and support.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. A backplane connector comprising:
a housing having a mating end and a mounting end for mounting to a substrate, one or more substrate receiving slots extending from the mating end toward the mounting end, ground shield support surfaces provided proximate the one or more substrate receiving slots;
signal contacts extending between the mating end and the mounting end, the signal contacts having resilient contact arms extending into the one or more substrate receiving slots;
at least one ground shield contact member extending between the mating end and the mounting end, the at least one ground shield contact member having working spring portions with openings provided therein, housing cooperating surfaces positioned at the periphery of the openings;
wherein the housing cooperating surfaces engage the ground shield support surfaces to allow forces applied to the housing to be transferred to the at least one ground shield contact member.

2. The backplane connector as recited in claim 1, wherein the ground shield support surfaces extend in a plane which is essentially parallel to a plane of the mounting end of the housing.

3. The backplane connector as recited in claim 2, wherein projections are provided on the housing and extend from the mounting end in a direction toward the mating end, the ground shield support surfaces are provided on the projections.

4. The backplane connector as recited in claim 3, wherein the projections have free ends which are spaced from the mounting end of the housing, ground shield receiving slots extend from the free ends toward the mounting end, the ground shield support surfaces are provided at the ends of the ground shield receiving slots.

5. The backplane connector as recited in claim 4, wherein the spacing between the projections is essentially equal.

6. The backplane connector as recited in claim 1, wherein working spring portions have a curved configuration.

7. The backplane connector as recited in claim 6, wherein ground shield resilient contact beams extend from first ends of the working spring portions.

8. The backplane connector as recited in claim 7, wherein the ground shield contact beams have ground shield resilient contact arms with lead in portions and an engagement portions.

9. The backplane connector as recited in claim 8, wherein longitudinal axes of the openings are in line with longitudinal axes of the ground shield resilient contact arms.

10. The backplane connector as recited in claim 6, wherein mounting members extend from second ends of the working spring portions.

11. The backplane connector as recited in claim 10, wherein the mounting members are spaced uniformly along the length of the working spring portions.

12. The backplane connector as recited in claim 10, wherein the mounting members are compliant members which are configured to engage and make an electrical connection with through holes of a backplane circuit board to which the backplane connector is mounted.

13. The backplane connector as recited in claim 1, wherein the openings are spaced uniformly along the length of the working spring portions.

14. The backplane connector as recited in claim 1, wherein the housing cooperating surfaces extend in a plane which is generally perpendicular to longitudinal axes of the openings and generally parallel to planes of ends of the working spring portions.

15. The backplane connector as recited in claim 1, wherein solid portions are positioned on the working spring portions between the openings, the solid portions are configured to optimize ground currents within the at least one ground shield contact member.

16. The backplane connector as recited in claim 1, wherein ground contacts are provided at the ends of the working spring portion, the ground contacts provide additional ground connections between ground shields of the daughtercard connector and the backplane.

17. A backplane connector comprising:
a housing having a mating end and a mounting end for mounting to a substrate, one or more substrate receiving slots extending from the mating end toward the mounting end, ground shield support surfaces provided proximate the one or more substrate receiving slots, the ground shield support surfaces extending in a plane which is essentially parallel to a plane of the mounting end;
signal contacts extending between the mating end and the mounting end, the signal contacts having resilient contact arms extending into the one or more substrate receiving slots;
at least one ground shield contact member extending between the mating end and the mounting end, the at least one ground shield contact member having a curved working spring portion with openings provided therein with housing cooperating surfaces positioned at the periphery of the openings, the at least one ground shield contact member having mounting compliant members extending from an end of the at least one ground shield contact member through the mounting end of the housing, solid portions extending between the openings, the solid portions configured to optimize ground currents within the at least one ground shield contact member;
wherein the housing cooperating surfaces engage the ground shield support surfaces to allow forces applied to the housing to be transferred to the at least one ground shield contact member.

18. The backplane connector as recited in claim 17, wherein projections are provided on the housing and extend from the mounting end in a direction away from the mating end, the projections have free ends which are spaced from the mounting end of the housing, ground shield receiving slots extend from the free ends toward the mounting end, the ground shield support surfaces are provided at the ends of the ground shield receiving slots.

19. The backplane connector as recited in claim 18, wherein the housing cooperating surfaces extend in a plane which is generally perpendicular to longitudinal axes of the openings and generally parallel to planes of ends of the working spring portions.

20. The backplane connector as recited in claim 19, wherein the longitudinal axes of the openings are in line with longitudinal axes of the ground shield resilient contact arms provided on the at least one ground shield contact member.
